(19) United States
(12) Patent Application Publication
(10) Pub. No.: US 2006/0268451 A1
(43) Pub. Date: Nov. 30, 2006

(54) Disk device

(75) Inventor: Takafumi Kikuchi, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/437,711

(22) Filed: May 22, 2006

(30) Foreign Application Priority Data
May 26, 2005 (JP) 2005-154059

(51) Int. Cl. G11B 17/00

(52) U.S. Cl. 360/97.01

(57) ABSTRACT

A housing of a disk device includes a rectangular base and a rectangular cover screwed to the base. The cover has a plurality of first through holes which are provided individually in four corner portions of the cover and in respective central parts of long side edges of the cover and through which screws are passed and screwed to the base, and a second through hole which is provided opposite the pivot and through which a screw is passed and screwed to the pivot. The cover includes an aperture formed in a triangle region which is opposed to the drive section and containing a center of gravity of the triangle, the triangle having vertices individually on a center of the second through hole and respective centers of those two of the first through holes which are located closest to the second through hole.

### CROSS-REFERENCE TO RELATED APPLICATIONS

This application is based upon and claims the benefit of priority from Japanese Patent Application No. 2005-154059, filed May 26, 2005, the entire contents of which are incorporated herein by reference.

### BACKGROUND

1. Field

One embodiment of the invention relates to a disk device having a disk for use as a recording medium.

2. Description of the Related Art

Recently, disk devices, such as magnetic disk devices, optical disk devices, etc., have been widely used as external recording devices for computers or video/audio recording and reproducing devices.

A magnetic disk device, for example, generally comprises a magnetic disk located in a housing, a spindle motor that supports and rotates the disk, a head actuator that supports magnetic heads, a voice coil motor for driving the head actuator, a circuit board unit, etc. The head actuator is provided with a bearing portion attached to a case and arms that are stack in layers on the bearing portion and extend from the bearing portion. A magnetic head is mounted on each arm by means of a suspension.

The housing includes an open-topped base on which mechanical units are mounted and a cover that covers an opening of the cover. Normally, the cover is screwed to the peripheral edge portion of the upper surface of the base by screws. The bearing portion of the head actuator has a pivot that is set up on the base. The distal end portion of the pivot is screwed to the cover. Thus, the pivot is supported at both ends when it is located in the housing.

The magnetic disk device constructed in this manner undergoes vibration that accompanies rotation of the spindle motor and the magnetic disk, vibration of the head actuator attributable to a windage that accompanies rotation of the magnetic disk, vibration that accompanies seek operation of the head actuator, etc. The vibrations of the spindle motor and the head actuator that serve as vibration generating elements are transmitted to the plate-shaped cover through the base, the pivot of the head actuator, etc. Thereupon, the cover vibrates and generates noise. If the frequency of normal mode of vibration of the cover is close to the frequencies of the vibrations transmitted to the cover, in particular, a resonance develops, so that the vibration amplitudes of the spindle motor and the head actuator increase. In consequence, the noise also increases inevitably.

In recent years, magnetic disk devices are used in various fields and expected to produce less noise. Proposed in, for example, Jpn. Pat. Appln. KOKAI Publication No. 2004-5783, therefore, is a magnetic disk device in which the plate thickness of the outer peripheral portion around a threaded hole through which a screw for fastening the pivot of the head actuator and the cover of the housing is passed is reduced. In the device arranged in this manner, the outer peripheral portion around the threaded hole is made less rigid than other portions so that vibration of the cover is reduced. By lowering the rigidity of the outer peripheral portion around the threaded hole, the vibration transmitted through the base and the pivot is attenuated, whereby the vibration of the cover is reduced.

In the magnetic disk device described in the above patent document, however, the pivot of the head actuator is supported at both ends by the cover and the base. If the rigidity of the outer peripheral portion around the threaded hole of the cover is lowered, therefore, self-oscillation of a positioning mechanism including the pivot increases, so that the reliability of the disk device may possibly be lowered.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary exploded perspective view showing a hard disk drive (HDD) according to a first embodiment of the invention;

FIG. 2 is an exemplary image showing a sound pressure mapping result at 3,240 Hz on the surface of a cover of the HDD;

FIG. 3 is an exemplary image showing a vibration mode of the cover of the HDD around 3,240 Hz;

FIG. 4 is an exemplary perspective view showing the cover of the HDD;

FIG. 5 is an exemplary diagram showing frequency analysis results on a sound pressure level measured in a position at a vertical distance of 300 mm from the surface of the cover;

FIG. 6 is an exemplary perspective view showing a cover of an HDD according to a second embodiment of the invention; and

FIG. 7 is an exemplary sectional view of the cover taken along line VII-VII of FIG. 6.

### DETAILED DESCRIPTION

Various embodiments according to the invention will be described hereinafter with reference to the accompanying drawings. In general, according to one embodiment of the invention, there is provided a disk device comprising: a housing having an open-topped rectangular base and a cover in the form of a rectangular plate which is screwed to the base and closes a top opening of the base; a magnetic disk arranged in the housing; a spindle motor which is mounted on the base and supports and rotates the magnetic disk; a head which records and reproduces information to and from the magnetic disk; and a head actuator which moves the head with respect to the magnetic disk, the head actuator comprising a bearing portion having a pivot fixed to the base and the cover, an arm extending from the bearing portion and supporting the head, and a drive section which is located on the side opposite from the arm with respect to the bearing portion and rotates the arm, the cover having a plurality of first through holes which are provided individually in four corner portions of the cover and in respective central parts of long side edges of the cover and through which screws which fasten the cover and the base to each other are passed, and a second through hole which is provided opposite the pivot and through which a screw which fastens the cover to the pivot is passed, the cover including an aperture formed at a position containing a center of gravity of a region which is shaped like a triangle and opposed to the drive section, the triangle having vertices individually on a center of the second through hole and respective centers of those two of the first through holes which are located closest to the second through hole.

A hard disk drive (HDD) according to a first embodiment of this invention will now be described in detail with reference to the accompanying drawings.

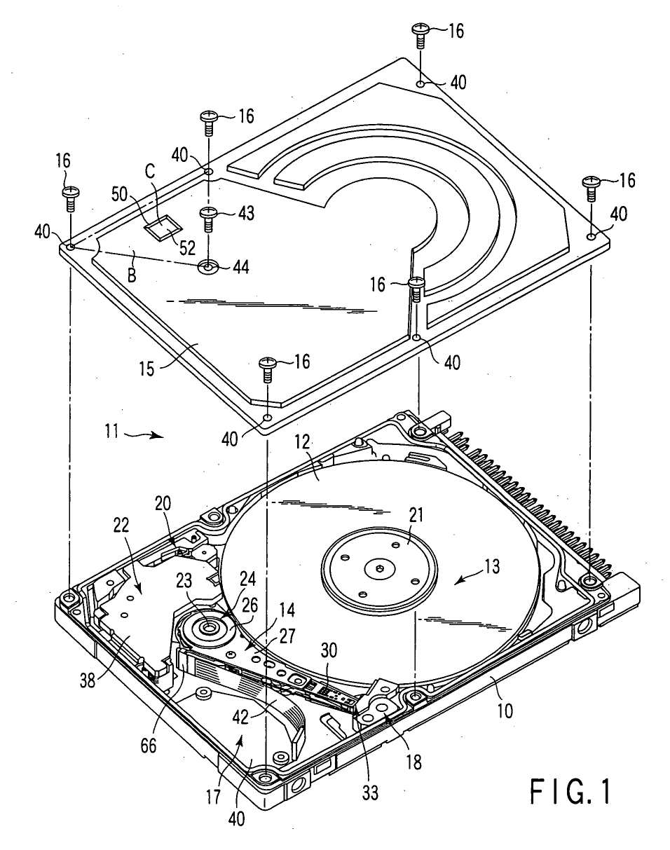

As shown in FIG. 1, the HDD comprises a housing 11. The housing 11 has a base 10 in the form of an open-topped rectangular box and a cover 15 in the form of a rectangular plate. The cover is fastened to the base by screws and closes a top opening of the base.

The base 10 contains therein a magnetic disk 12 for use as a recording medium, spindle motor 13, magnetic heads 33, head actuator 14, voice coil motor (VCM) 22, ramp load mechanism 18, inertia latch mechanism 20, and flexible printed circuit board unit (FPC unit) 17. The spindle motor 13 supports and rotates the magnetic disk. The magnetic heads 33 record and reproduce information to and from the disk 12. The head actuator 14 supports the magnetic heads 33 for movement with respect to the disk 12. The VCM 22 rotates and positions the head actuator. The ramp load mechanism 18 holds the magnetic heads 33 at distances from the magnetic disk 12 when the heads are moved to the outermost periphery of the disk. The inertia latch mechanism 20 holds the head actuator 14 in a retreated position if a shock or the like acts on the HDD. Electronic devices, such as a pre-amplifier, are mounted on the FPC unit 17.

The spindle motor 13, the VCM 22, and a printed circuit board (not shown) for controlling the operation of the magnetic heads 33 are screwed to the outer surface of the base 10 through the FPC unit 17, and are situated opposite a bottom wall of the base 10.

The magnetic disk 12 is, for example, 65 mm (2.5 inches) in diameter and has magnetic recording layers on its upper and lower surfaces, individually. The disk 12 is coaxially fitted on a hub (not shown) of the spindle motor 13, clamped. by a clamp spring 21, and fixed to the hub. The magnetic disk 12 is rotated at a predetermined speed, e.g., at 5,400 rpm, by the spindle motor 13 as a driver.

The head actuator 14 is provided with a bearing assembly 24 that is fixed on the bottom wall of the base 10. The bearing assembly 24, which serves as a bearing portion, has a pivot 23 set up on the bottom wall of the base 10 and a cylindrical hub 26 that is rotatably supported on the pivot by a pair of bearings. The head actuator 14 comprises two arms 27 attached to the hub 26, two suspensions 30 extending from the arms, individually, the magnetic heads 33 supported on respective extended ends of the suspensions, individually, and spacer rings.

Each magnetic head 33 has a substantially rectangular slider (not shown) and a read/write magnetic resistance (MR) head element formed on the slider, and is fixed to a gimbals portion formed on the distal end portion of each suspension 30. Each magnetic head 33 is connected electrically to a main FPC 42 (mentioned later) through a relay FPC (not shown). The relay FPC is pasted on respective surfaces of each arm 27 and each reinforcement member 30 of the head actuator 14 and extends from the distal end of the suspension and a rocking proximal end of the arm. The relay FPC is in the form of an elongate belt as a whole. Its distal end is connected electrically to the magnetic head 33, and its proximal end portion to the main FPC 42. Thus, each magnetic head 33 is connected electrically to the FPC unit 17 through the relay FPC and the main FPC 42.

The arms 27 that are fitted on the hub 26 are situated extending parallel to each other with a predetermined space between them so that the suspensions 30 and the magnetic heads 33 on the arms face one another. The VCM 22 has a support frame (not shown) mounted on the hub 26 so as to extend in the direction opposite from the arm 27 and a voice coil supported on the support frame. When the head actuator 14 is incorporated in the base 10, the voice coil is situated between a pair of yokes 38 that are fixed on the base 10. The voice coil, the yokes, and a magnet (not shown) fixed to one of the yokes constitute the VCM 22. When the voice coil is energized, the head actuator 14 rotates, whereupon each magnetic head 33 is moved to and positioned in an area over a desired track.

The rectangular cover 15 is formed by press-molding an aluminum alloy plate with a plate thickness of, for example, 0.4 mm. First through holes 40 are formed individually in four corner portions of the cover 15 and in respective substantial centers of a pair of long side edges of the cover. The cover 15 is fastened to the base 10 in a manner such that screws 16 that are passed individually through the first through holes 40 are screwed into threaded holes in the peripheral edge portion of the base, and closes the top opening of the base. The cover 15 faces the magnetic disk 12 in parallel to each other with a predetermined gap.

A second through hole 44 is formed in that part of the cover 15 which faces the pivot 23 of the bearing assembly 24. A part of the cover 15 and the pivot 23 are fastened to each other in a manner such that a fixing screw 43 passed through the second through hole 44 is screwed into the upper end portion of the pivot 23. Accordingly, the opposite end portions of the pivot 23 are supported individually by the base 10 and the cover 15 of the housing 11. Thus, the cover 15 has the six first through holes 40 for screwing in the peripheral edge portion and the second through hole 44 for screwing over the pivot 23.

FIG. 5 shows frequency analysis results on a sound pressure level measured in a position at a vertical distance of 300 mm from the surface of the cover 15 with HDD's of the aforesaid construction kept idling at 5,400 rpm. In FIG. 5, a broken line R2 represents a frequency analysis result on an HDD that is not provided with an aperture 50 (mentioned later) in the cover 15. As seen from FIG. 5, a discrete peak is prominent at 3,240 Hz. This peak is attributable to an electromagnetic sound of the spindle motor 13, and the prominent frequency is settled depending on composition conditions of the spindle motor, that is, the number of stator slots and the number of rotor poles. In the case of a 2.5-inch HDD in which a magnetic disk is rotated at a rotational speed of 5,400 rpm, in general, an electromagnetic sound of a component that is 36 times higher than the rotational frequency (90 Hz) is prominent. The electromagnetic sound that is attributable to the spindle motor 13 has come to be noticed as a sound that is harsh to the human ear. Accordingly, the present embodiment is arranged so that the discrete-frequency sound can be attenuated.

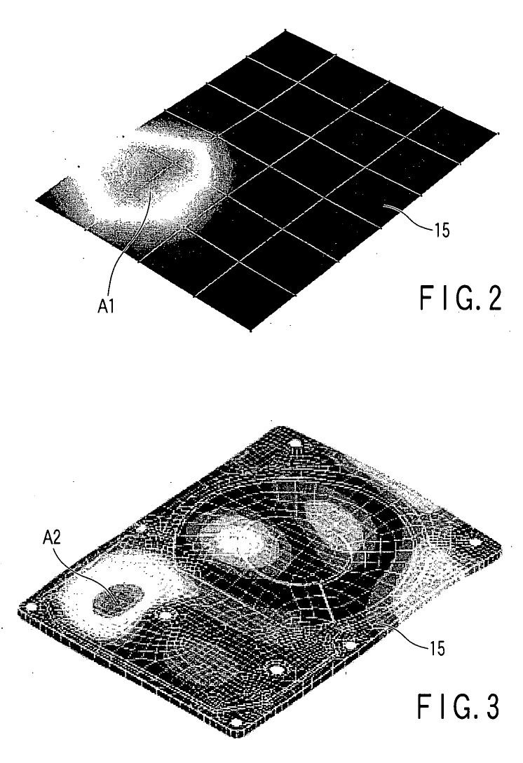

FIG. 2 shows a sound pressure mapping result at 3,240 Hz on the surface of the cover 15 of a 2.5-inch HDD in an idling state at 5,400 rpm. The sound pressure mapping is an effective method of sound source searching in which sound pressure levels near the HDD, along with phase information, are measured in a lattice on a two-dimensional plane, and the obtained sound pressure levels are plotted together with the phase information. In FIG. 2, a somewhat dark region Al that is situated in the center of a substantially circular, light-colored region indicates a high sound pressure. It can be concluded from this result that the region Al right over the VCM 22 becomes a sound source on the surface of the cover 15 at 3,240 Hz.

FIG. 3 shows a simulation result based on a finite element method, and illustrates a vibration mode of the cover 15 around 3,240 Hz in the HDD according to the present embodiment. As recognized in FIG. 3, there is a vibration mode in which the amplitude of the cover 15 is larger in a region A2 right over the VCM 22. The region A2 of the larger amplitude in the same mode is substantially coincident with the sound source region Al shown in FIG. 2. Thus, the discrete-frequency sound of the 36^{th} order shown in FIG. 2 can be supposed to have been amplified by resonance of the cover 15.

The vibration mode of the cover 15 is influenced more considerably by the position of screw connection between the cover 15 and the base 10, cover material, and cover plate thickness than by the shape of the cover itself. In the case of an HDD of which the housing 11 externally measures 9.5 mm (height)×70 mm (width)×100 mm (depth) and contains the magnetic disk 12 of 2.5-inch diameter, a screwing position for cover fastening is substantially coincident with those of any other HDD's of the same specifications, owing to spatial requirements. In general, the cover 15 of a 2.5-inch HDD is formed by press-molding an aluminum alloy plate, and its thickness is minimized to reduce its weight and cost. The thickness of the cover 15 used in the sound pressure mapping measurement shown in FIG. 2 and the determination of the simulation result shown in FIG. 3 is 0.4 mm. Thus, in the case of the 2.5-inch HDD having the cover 15 formed of an aluminum alloy, the vibration mode shown in FIG. 3 is supposed to exist around 3,240 Hz.

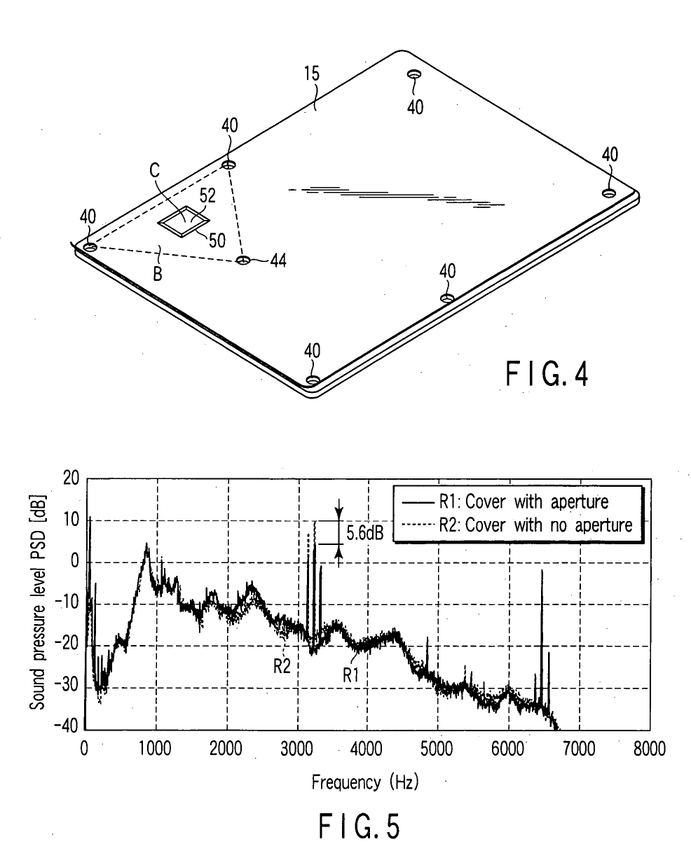

FIG. 4 shows the cover 15 of the HDD according to the present embodiment. In the cover 15, the rectangular aperture 50 is formed in a region B shaped like a triangle so as to contain the gravity center C of the triangle region B. The triangle has its vertices individually on the center of the second through hole 44, which is connected to the base 10 by the pivot 23, and the respective centers of those two of the six first through holes 40 which are located closest to the second through hole 44. The gravity center C of the region B is substantially coincident with the region A2 in which the vibration mode shown in FIG. 3 has its largest amplitude. Therefore, an effect to enhance the resonance frequency can be obtained by forming the aperture 50 in the cover 15 in this position to reduce the mass of an oscillator. Thus, resonance of the cover 15 with the 36^{th}-order discrete-frequency sound can be avoided to lower the peak value of the discrete-frequency sound.

The size of the aperture 50 is settled depending on the degree of shift of the resonance frequency. More specifically, the larger the aperture 50, the less the mass of the cover 15 in the region B is, and the higher the resonance frequency is. The frequency of the sound pressure level was measured for an HDD in which a square hole measuring 10 mm×10 mm was formed as the aperture 50 in the cover 15 so as to contain the gravity center C. An analysis result of the measurement is represented by a solid line R1 in FIG. 5. In order to prevent dust particles or the like from getting into the housing 11, the aperture 50 of the cover 15 is closed by a seal 52. In the HDD according to the present embodiment, compared with an HDD without the aperture 50 in its cover 15, the peak value at 3,240 Hz was reduced by about 5.6 db without failing to minimizing the increase of the general noise level, as shown in FIG. 5.

According to the HDD of the present embodiment, as described above, the cover 15 of the housing 11 is provided with the aperture 50 that is situated in a position that contains the gravity center C of the triangular region B. In this case, the triangle of the region B has its vertices individually on the center of the second through hole 44, through which the fixing screw 43 for threadedly fastening the pivot 23 of the bearing portion and the cover 15 together is passed, and the respective centers of those two first through holes 40 which are located closest to the second through hole 44, among the other first through holes 40 through which the screws 16 for threadedly fastening the cover 15 and the base 10 together are passed. This situation is established when the region B is defined to be flush with the cover 15. Accordingly, the resonance frequency of the cover 15 around 3,240 Hz can be enhanced, and the discrete-frequency sound around 3,240 Hz that is harsh to the human ear can be attenuated. Since the aperture 50 is located at a distance from a support portion for the pivot 23 of the bearing portion, moreover, reduction of the rigidity of the support portion can be prevented, and self-oscillation of a positioning portion including the pivot 23 can be restrained. Thus, there may be obtained a high-reliability HDD of a simple construction capable of reducing noise without increasing manufacturing costs.

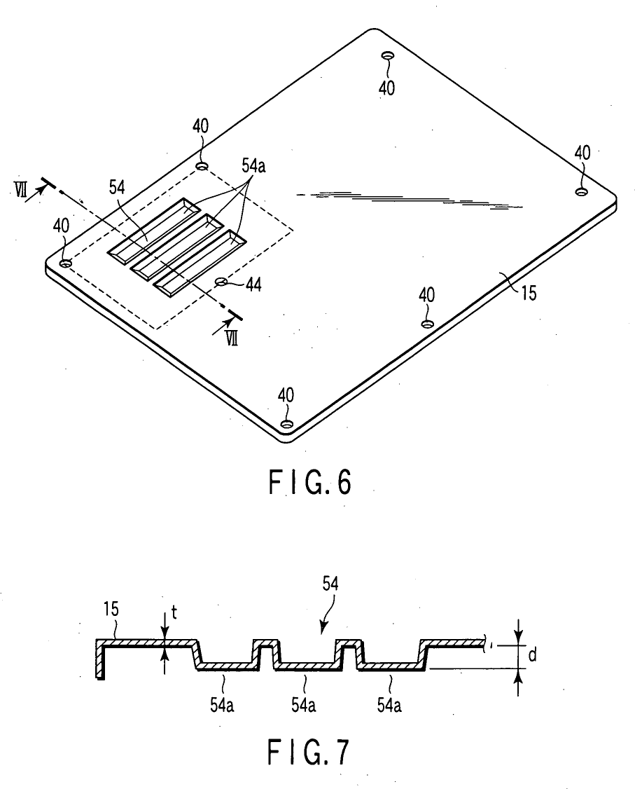

The following is a description of an HDD according to a second embodiment of the invention. FIG. 6 shows a cover 15 of the HDD, and FIG. 7 shows a cross section of the cover. The cover 15 in the form of a rectangular plate is formed by press-molding an aluminum alloy plate with a plate thickness of, for example, 0.4 mm. First through holes 40 are formed individually in four corner portions of the cover 15 and in respective substantial centers of a pair of long side edges of the cover. The cover 15 is fastened to a base of a housing in a manner such that screws that are passed individually through the first through holes 40 are screwed into threaded holes in the peripheral edge portion of the base, and closes a top opening of the base.

A second through hole 44 is formed in that part of the cover 15 which faces the pivot 23 of the aforementioned bearing assembly. A part of the cover 15 and the pivot 23 are fastened to each other in a manner such that a fixing screw passed through the second through hole 44 is screwed into the upper end portion of the pivot. The cover 15 has the six first through holes 40 for screwing in the peripheral edge portion and the second through hole 44 for screwing over the pivot 23.

Further, the cover 15 is provided with a corrugated portion 54 that is formed by press-molding and has a height d greater than a plate thickness t of the cover. The corrugated portion 54 is situated in a region D shaped like a rectangle of which each side extends parallel to the contour of the cover 15. The sides of the rectangle contain the center of the second through hole 44, which is connected to the base by the pivot, and the respective centers of those two of the six first through holes 40 which are located closest to the second through hole 44. The corrugated portion 54 includes a plurality of rectangular ribs 54a that extend parallel to the long sides of the region D.

Since the corrugated portion 54 is located in the region D that corresponds to the region A2 in which the vibration mode shown in FIG. 3 has a large amplitude, that is, in the region right over the VCM 22 in this case, the rigidity of the cover 15 is increased, and the resonance frequency of the cover 15 around 3,240 Hz can be enhanced. Thus, the discrete-frequency sound around 3,240 Hz that is harsh to the human ear can be attenuated. Since the corrugated portion 54 can be press-molded integrally with the cover 15, moreover, noise can be reduced by a simple construction without increasing manufacturing costs.

Since the second embodiment shares other configurations of the HDD with the first embodiment, like reference numerals are used to designate like portions of these embodiments, and a detailed description of those portions is omitted.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, the shape of the aperture or the corrugated portion in the cover is not limited to the one described in connection with each of the embodiments but may be modified variously. The resonance frequency can be enhanced by reducing the mass of the cover or increasing its rigidity in the region where the amplitude of the vibration mode of the cover is large. Thus, both the aperture and the corrugated portion may be formed in combination in the region for the large vibration-mode amplitude.

What is claimed is:

1. A disk device comprising:
a housing having an open-topped rectangular base and a cover in the form of a rectangular plate which is screwed to the base and closes a top opening of the base;
a magnetic disk arranged in the housing;
a spindle motor which is mounted on the base and supports and rotates the magnetic disk;
a head which records and reproduces information to and from the magnetic disk; and
a head actuator which moves the head with respect to the magnetic disk,
the head actuator comprising a bearing portion having a pivot fixed to the base and the cover, an arm extending from the bearing portion and supporting the head, and a drive section which is located on the side opposite from the arm with respect to the bearing portion and rotates the arm,
the cover having a plurality of first through holes which are provided individually in four corner portions of the cover and in respective central parts of long side edges of the cover and through which screws which fasten the cover and the base to each other are passed, and a second through hole which is provided opposite the pivot and through which a screw which fastens the cover to the pivot is passed,
the cover including an aperture formed in a region shaped like a triangle and opposed to the drive section so as to contain a center of gravity of the triangle, the triangle having vertices individually on a center of the second through hole and respective centers of those two of the first through holes which are located closest to the second through hole.

2. A disk device according to claim 1, wherein the cover includes a seal which covers and closes the aperture.

3. A disk device according to claim 1, wherein the cover is formed of an aluminum alloy plate, and the magnetic disk has a diameter of 2.5 inches.

4. A disk device comprising:
a housing having an open-topped rectangular base and a cover in the form of a rectangular plate which is screwed to the base and closes a top opening of the base;
a magnetic disk arranged in the housing;
a spindle motor which is mounted on the base and supports and rotates the magnetic disk;
a head which records and reproduces information to and from the magnetic disk; and
a head actuator which moves the head with respect to the magnetic disk,
the head actuator comprising a bearing portion having a pivot fixed to the base and the cover, an arm extending from the bearing portion and supporting the head, and a drive section which is located on the side opposite from the arm with respect to the bearing portion and rocks the arm,
the cover having a plurality of first through holes which are provided individually in four corner portions of the cover and in respective central parts of long side edges of the cover and through which screws which fasten the cover and the base to each other are passed, and a second through hole which is provided opposite the pivot and through which a screw which fastens the cover to the pivot is passed,
the cover including a corrugated portion formed in a region shaped like a rectangle and opposed to the drive section, the rectangle having sides which extend substantially parallel to a contour of the cover and contain a center of the second through hole and respective centers of those two of the first through holes which are located closest to the second through hole.

5. A disk device according to claim 4, wherein the corrugated portion has an indentation depth greater than a plate thickness of the cover.

6. A disk device according to claim 4, wherein the corrugated portion includes a plurality of ribs extending parallel to long sides of the rectangular region.

7. A disk device according to claim 4, wherein the cover is formed of an aluminum alloy plate, and the magnetic disk has a diameter of 2.5 inches.
